(19) United States
(12) Patent Application Publication
(10) Pub. No.: US 2022/0408904 A1
(43) Pub. Date: Dec. 29, 2022

(54) MOSQUITO NET OF A COMPARTMENT OF AN ACCESS OF A VEHICLE

(71) Applicant: LCI ITALY S.R.L., Florence (IT)

(72) Inventor: Bruno MIRONE, Poggibonsi (IT)

(21) Appl. No.: 17/851,377

(22) Filed: Jun. 28, 2022

(30) Foreign Application Priority Data
Jun. 29, 2021 (IT) 102021000017003

(51) Int. Cl. A45F 3/52

(52) U.S. Cl. CPC A45F 3/52

(57) ABSTRACT

A mosquito net of a compartment of an access of a vehicle with a floor and a riser includes a frame and a curtain connected to the frame. The frame includes a first vertical upright, a top rail and a bottom rail configured to be secured to the vehicle, and a second upright free to slide on the top rail and bottom rail.

### CROSS-REFERENCES TO RELATED APPLICATIONS

This application claims priority of Italian Patent Application No. 102021000017003 filed Jun. 29, 2021, the entire contents of which are hereby incorporated by reference in this application.

### STATEMENT REGARDING FEDERALLY SPONSORED RESEARCH OR DEVELOPMENT

(NOT APPLICABLE)

### BACKGROUND

This invention relates to a mosquito net of a compartment of an access of a vehicle.

More specifically, the invention relates to the sector of vans, mini-vans, camper vans or the like, also known as “recreational vehicles”, that is to say, suitable for leisure time and such as to comprise a habitable space. In order to access the habitable space there is a compartment giving access to the vehicle, closed by a door during travel.

More specifically, in the vans and mini-vans, the door is usually kept open during breaks, even just so as to increase the brightness and the air circulation. Obviously, in these conditions, the use of a mosquito net, that is to say, a screen against insects, is of considerable importance and frequently requested.

The prior art solutions of mosquito nets comprise, for example, the use of loose curtains, fixed with adhesives to the compartment of the access to the vehicle.

These solutions, although convenient, especially from an economic point of view, have the drawback of being not very stable, and of easily losing adherence to the vehicle, thus compromising their screening function.

There are also prior art solutions which comprise a frame fixed in the compartment of the vehicle which have the advantage of guaranteeing a greater stability and duration of the mosquito net, in the desired position. However, these solutions also have drawbacks.

More specifically, the frame has a bottom rail which is fixed on the floor of the vehicle, and more specifically of the usable space.

These bottom rails have significant dimensions, usually in the order of a few centimetres in terms of thickness which rises from the floor of the vehicle, forming an actual step inside the habitable space.

This step represents a possible source of danger since if, in fact, it is not seen, it risks constituting an obstacle or an element for tripping the occupants of the vehicle, thus compromising the safety of the habitable space.

Moreover, the step prevents a correct cleaning of the room, forming a point for accumulation of dust and dirt. Even more, the rails usually have an upper slit designed for the sliding of the curtain of the mosquito net.

It is clear that said slit becomes a further point for accumulation of dust and dirt.

Moreover, these prior art solutions are more easily subject to wear, after the walking on of the rail by the occupants of the vehicle during entry and exit into/out of the habitable space.

This deforms the rail in which the curtain of the mosquito net slides, adversely affecting its use over time.

Also visually, the currently known bottom rails are an element which occupies space and prevents the implementation of solutions in which it is possible to completely have available the habitable space, and in which the space can be fully seen.

### SUMMARY

An aim of the described embodiments is therefore to provide a mosquito net of a compartment of an access of a vehicle which is able to overcome the above-mentioned drawbacks of the prior art.

A further aim of the described embodiments is to provide a mosquito net of a compartment of an access of a vehicle which is at the same time practical to use and simple and inexpensive to make.

Another aim of the described embodiments is to provide a mosquito net of a compartment of an access of a vehicle with reduced dimensions and a high resistance to treading on.

According to the described embodiments, these aims and others are achieved by a mosquito net of a compartment of an access of a vehicle comprising the technical features described in the appended claims.

### BRIEF DESCRIPTION OF THE DRAWINGS

The technical features of the described embodiments, with reference to the above-mentioned aims, are clearly described in the appended claims and its advantages are apparent from the detailed description which follows, with reference to the accompanying drawings which illustrate purely non-limiting example embodiments of the invention, in which:

FIG. 1 is a schematic perspective view of an embodiment of the mosquito net of a compartment of an access of a vehicle according to the described embodiments;

FIG. 2 is a schematic axonometric view of the mosquito net of FIG. 1;

FIGS. 3 and 4 are schematic front elevation views of a detail of the mosquito net of FIG. 1 according to two different embodiments;

FIGS. 5 and 6 are, respectively, a schematic front elevation view and a top elevation view of the mosquito net of FIG. 1;

FIG. 7 is a schematic perspective view, with some parts cut away to better illustrate others, of the mosquito net of FIG. 1.

### DETAILED DESCRIPTION

With reference to the accompanying drawings, the numeral 1 denotes in its entirety a mosquito net of a compartment A of an access of a vehicle V made in accordance with the described embodiments, hereinafter also referred to simply as the mosquito net 1.

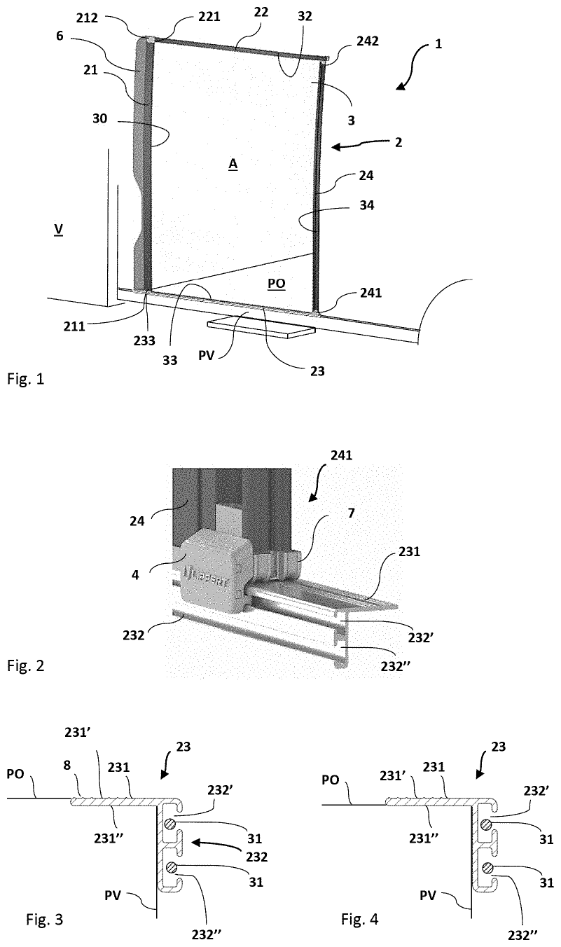

More specifically, the vehicle V comprises a floor PO and a riser PV, as illustrated in FIG. 1.

With reference to the accompanying drawings, the mosquito net 1 comprises a frame 2 configured to be constrained to the vehicle V, and a curtain 3 connected to the frame 2.

The frame 2 comprises a first vertical upright 21, an top rail 22 and a bottom rail 23 configured to be fixed to the vehicle V.

The term “vertical” means a direction belonging to a plane at right angles to a ground plane, wherein the ground plane coincides with the ground.

The frame 2 also comprises a second upright 24 free to slide on the top rail 22 and bottom rail 23 to pass from a first non-operating configuration CC, wherein the curtain 3 is positioned fully at the first upright 21, to at least a second operating configuration AA, wherein the curtain 3 is at least partly extended between the first upright 21 and the second upright 24.

More specifically, the first upright 21 has a first 211 and a second 212 end, opposite to the main direction of extension of the first upright 21.

The first upright 21 is positioned with its first end 211 resting on the floor PO, as illustrated in FIG. 1. The top rail 22 and the bottom rail 23 are positioned transversally to the first upright 21, and are positioned with a relative first end 221 and 233 at, respectively, the second end 212 and the first end 211 of the first upright 21.

At the ends 211 and 212 of the first upright 21 there are corner elements, not illustrated, to facilitate assembly of the top rail 22 and bottom rail 23.

The second upright 24 is interposed between the top rail 22 and the bottom rail 23.

The second upright 24 has a first end 241 and a second end 242, positioned according to the main direction of extension of the upright, as illustrated in FIG. 1.

Advantageously, the bottom rail 23 is rectilinear, that is to say, it has a main rectilinear longitudinal axis of extension.

This facilitates the sliding of the curtain 3 and of the second upright 24 during the passage from the first non-operating configuration CC to at least a second operating configuration AA.

The top rail 22 has a main longitudinal axis of extension at least partly curved.

More specifically, the curvature of the top rail 22 is in the part closest to the head of the vehicle V.

In effect, the shape of the vehicles normally tends to taper from the centre of the vehicle towards the axle of the front wheels in a plane containing the ground surface.

In order to adapt the top rail 22 to the tapering of the vehicle V in a plane parallel to the ground plane, the main longitudinal axis of extension of the top rail 22 is at least partly curved.

Advantageously, the first 21 and the second 24 upright have a main longitudinal axis of extension at least partly curved to adapt to the compartment A of the vehicle V.

In effect, similarly to what was stated above, the shape of the vehicles normally tends to taper from the ground plane towards the roof of the vehicle in a plane containing the rear or front axle of the wheels.

The main longitudinal axis of extension of the first upright 21 and of the second upright 24 is at least partly curved, to adapt the first upright 21 and the second upright 24 to the tapering of the vehicle V in a plane parallel to the plane containing the rear or front axle of the wheels.

As illustrated in FIG. 6, the top rail 22 and the bottom rail 23 are offset from each other in a top view (that is to say, in a plane parallel to the ground plane).

This is due to the curvature of the first 21 and the second 24 upright.

Advantageously, the frame 2 is made with profiles made of aluminium, plastic, or a combination of these materials, so that they can be easily curved or adapted to the shape and size of the vehicle V.

According to other embodiments, the frame 2 is made of elastically deformable materials, so that they can be adapted to the shape and size of the vehicle V, without the need to pre-machine the uprights or rails.

The curtain 3 comprises four end edges 30, 32, 33, 34, as illustrated in FIG. 1, which face, respectively, the first upright 21, the top rail 22, the bottom rail 23, and the second upright 24.

The end edges 30 and 34 of the curtain 3 which are, respectively, at the first upright 21 and the second upright 24 are, in use, stably connected to them, whilst the edges 32 and 33 which are, respectively, at the top rail 22 and bottom rail 23 are free from constraints in order to be able to advance along the respective rails. Advantageously, the curtain 3 is retractable, that is to say, it is made of flexible material so that it can be folded back on itself, in the first non-operating configuration CC.

According to some embodiments not illustrated, the curtain 3 has a concertina shape, to facilitate its packing in the first non-operating configuration CC. When the curtain 3 is folded, the overall size of the first upright 21 and the second upright 24 is reduced, with respect to the configurations in which the curtain 3 is wound on itself with a circular movement.

The curtain 3 is made of a flexible natural or synthetic fabric, in the form of a mesh or a continuous surface, or a combination of these materials or elements.

The bottom rail 23 has a transversal cross-section—with respect to the main direction of extension of the bottom rail 23—and is L-shaped, comprising a first flap 231 and a second flap 232.

The first flap 231 and the second flap 232 are configured to be positioned in direct contact, respectively, with the floor PO and with the riser PV of the vehicle V, as illustrated in FIGS. 3, 4, and 7.

In this way, the bottom rail 23 is positioned on an end edge of the floor PO.

Advantageously, the first 231 and the second 232 flap are at right angles to each other.

Advantageously, the bottom rail 23 has an extremely reduced thickness which rises from the visible surface of the floor PO, with respect to the prior art solutions.

FIGS. 3 and 4 illustrate two different embodiments where the first flap 231 is in direct contact with the floor PO.

More specifically, the first flap 231 has an upper walkable surface 231′ and a lower supporting surface 231″.

The upper walkable surface 231′ and the lower supporting surface 231″ define two flat surfaces facing each other. According to a first embodiment, illustrated in FIG. 3, the upper walkable surface 231′ is positioned on the same plane containing the floor PO.

This embodiment represents the minimum thickness of the bottom rail 23 which rises from the visible surface of the floor PO, that is to say, when the latter is flush with the plane defined by the floor PO, and the bottom rail 23 is inserted in the thickness of the floor.

According to a second embodiment, illustrated in FIG. 4, the lower supporting surface 231″ is positioned on the same plane containing the floor PO.

This embodiment represents the maximum thickness which can be occupied by the bottom rail 23, that is to say, when it is rested on the surface on view of the floor PO.

This embodiment is, for example, illustrated in FIG. 7.

As illustrated in FIGS. 1, 2 and 7, one between the first end 241 and the second end 242 of the second upright 24 slides on the first flap 231 of the bottom rail 23.

More specifically, with reference to the accompanying drawings, the first end 241 of the second upright 24 slides on the first flap 231.

Advantageously, the first flap 231 has a continuous surface without slits.

In this way, the bottom rail 23 can be kept perfectly operational and clean with extreme ease.

The curtain 3 comprises at least one rope 31 tensioned between the first 21 and the second 24 upright.

In that way it is possible to adjust the tension of the curtain 3, in such a way as to create a correct screening from the insects and a complete covering of the compartment A giving access to the vehicle V.

Advantageously, the tensioning ropes 31 pass in the first 21 and second 24 upright at the respective height, for a more homogeneous tensioning.

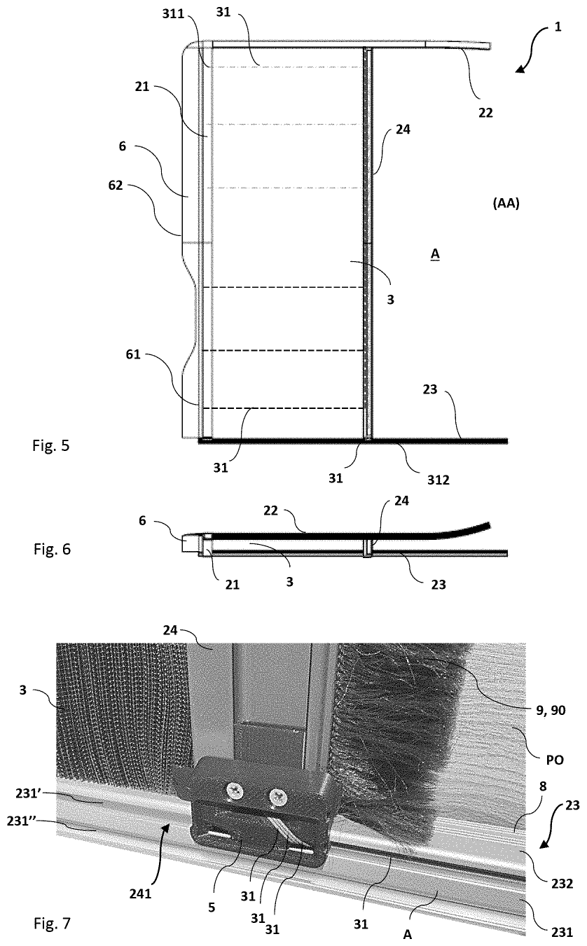

At least one tensioning rope 31 is stably connected with its first end 311 to the first upright 21 and is free to slide at least partly inside the second upright 24, as illustrated in FIG. 5.

At least one tensioning rope 31 is stably engaged with a relative second end 312 in a fixed position of one of either the top 22 or bottom 23 rails.

In this way, the curtain 3 is easily closed and opened, maintaining an adequate tensioning of the curtain 3. Moreover, in this way it is possible to hide from view the tensioning ropes 31 inside the first 21 and the second 24 upright, at the uprights themselves.

This makes it possible to protect the tensioning ropes 31 from any extraneous agents.

With reference to the accompanying drawings, and in particular to FIGS. 5 and 7, the curtain 3 comprises six tensioning ropes 31.

Advantageously, three of the six tensioning ropes 31 are connected in a fixed position of the top rail 22 and the other three tensioning ropes 31 are connected in a fixed position of the bottom rail 23.

In that way, the curtain 3 is sufficiently tensioned at the top and bottom, so as to avoid over-tensioning which might cause the curtain to break or weaken.

The mosquito net 1 also comprises guiding means 4 of the second upright 24, as illustrated in FIG. 2.

With reference to the accompanying drawings, the guide means 4 are positioned at the end 241 of the second upright 24 which slides on the first flap 231 of the bottom rail 23.

This makes it possible to maintain the sliding of the second upright 24 along the bottom rail 23.

Advantageously, the second upright 224 has end caps 7, for facilitating the sliding and cleanliness of the second upright 24.

The second flap 232 of the bottom rail 23 has a first rail 232′.

The first rail 232′ runs along the length of the bottom rail 23, entirely or partly.

The guide means 4 are configured to engage with the first rail 232′ which is in turn configured to maintain the sliding of the guide means 4 along a predetermined direction.

This facilitates correct sliding of the second upright 24.

The mosquito net 1 comprises a collector 5, illustrated in FIG. 7, of one or more tensioning ropes 31 integral with the guide means 4.

In this way, the tensioning ropes 31 at the outfeed from the end 241 of the second upright 24 which slides on the first flap 231 are collected and conveyed towards the first rail 232′.

With reference to the accompanying drawings, the collector 5 collects three tensioning ropes 31 at the outfeed from the end 241 of the second upright 24 and overturns them for inserting them correctly inside the first rail 232′.

Advantageously, the second flap 232 has a second rail 232″.

With reference to the accompanying drawings, the second rail 232″ is parallel to the first rail 232′.

This avoids over-tensioning of the tensioning ropes 31. When the second rail 232″ is present, the fixed position in which the tensioning ropes 31 are stably connected with their second end 312 is a predetermined position along the second rail 232″.

The fixed position is determined on the basis of the correct, or selected, tensioning of the curtain 3.

The use of the first 232′ and the second 232″ rail allows the ropes 31 of the mosquito net 1 to be kept taught.

Moreover, the fact that the second flap 232 is at the riser PV allows the exposure of the tensioning ropes 31 to extraneous agents to be considerably reduced.

Also, the insertion of the tensioning ropes 31 into the first rail 232′ and the second rail 232″ makes it possible to hide them, or almost, from view.

A collector 5, not illustrated, is also provided at the end 242 of the second upright 24 for collecting the tensioning ropes 31 feeding out of the second end 242 and returned to the top rail 22.

The bottom rail 23 is fixed to the floor PO, for example by means of fixing screws, or adhesives, positioned at the first 231 and/or the second 232 flap.

Similar fixing is used for the first upright 21 and the top rail 22.

With reference to the accompanying drawings, the mosquito net 1 comprises a compensation element 6 constrained with a relative first end vertical edge 61 to the first upright 21, and with a relative second end vertical edge to the vehicle V, for adapting the frame 2 to different shapes of the vehicle V, as illustrated in FIG. 5.

The upper walkable surface 231′ of the bottom rail 23 comprises non-slip means 8, such as, for example, illustrated in FIGS. 3 and 7.

With reference to the accompanying drawings, the mosquito net 1 comprises filling means 9 positioned at a vertical end edge of the second upright 24 and such as to project towards the outside of the frame 2.

In that way, any empty spaces are filled between the second upright 24 and the vehicle V, when the second upright 24 is at an end stop or at an end of one between the bottom rail 23 and the top rail 22.

With reference to FIG. 7, the brush 90 defines the filling means 9 for the mosquito net 1.

According to embodiments not illustrated, the mosquito net 1 comprises elastic means for returning the tensioning ropes 31, to prevent over-tensioning of the ropes and/or facilitate closing of the mosquito net 1. The elastic return means are positioned inside one of either the first 21 or the second 24 upright.

Advantageously, the elastic means are positioned inside the first upright 21 to increase the return force of the curtain 3.

Elastic springs define the elastic means, not illustrated, for the mosquito net 1.

According to embodiments not illustrated, the first upright 21 and the second upright 24, and the top rail 22 and the bottom rail 23 have a transversal profile which is symmetrical with respect to its main axis of extension.

In this way, the frame 2 is easily adapted to vehicles V with right-hand drive and to vehicles V with left-hand drive, which require different curvatures.

According to embodiments not illustrated, at least one between the top rail 22 and the bottom rail 23 has an end of stroke element.

In use, the bottom rail 23 and the top rail 22, and the first upright 21 are fixed to the access compartment A of a door of a vehicle V, and the second upright 24 is inserted between the top rail 22 and the bottom rail 23. The end edge 30 of the curtain 3 is stably connected to the first upright 21.

After that, the tensioning of the tensioning ropes 31 is adjusted, fixing them in a fixed position along the second rail 232″.

The mosquito net of a compartment of an access of a vehicle according to the described embodiments achieves the preset aims and brings important advantages.

A first advantage of the mosquito net according to the described embodiments is the possibility of reducing to a minimum, or not to have, projections rising from the floor PO following installation of the bottom rail 23 of the mosquito net.

A further advantage is the possibility of increasing the working life of the bottom rail 23 and of the entire mosquito net.

A further advantage is due to the fact that the mosquito net can be cleaned more easily, as well as accumulating less dirt, thereby contributing to guaranteeing a correct sliding of the curtain.

Yet another advantage is due to the possibility of adapting the mosquito net to different shapes or sizes of the recreational vehicles.

1. A mosquito net of a compartment of an access of a vehicle, wherein said vehicle comprises a floor and a riser, said mosquito net comprising:
a frame configured to be engaged to said vehicle, a curtain connected to said frame, said frame comprising a first vertical upright, a top rail and a bottom rail configured to be secured to said vehicle, said frame further comprising a second upright free to slide on said top rails and bottom rails to move from a first non-operational configuration, wherein said curtain is all arranged at said first upright, to at least a second operational configuration, wherein said curtain is at least partially extended between said first upright and said second upright, wherein said bottom rail has an L-shaped cross-section, comprising a first and a second flap, wherein said first and second flaps are configured to be arranged in direct contact respectively with said floor and with said riser of said vehicle.

2. The mosquito net according to claim 1, wherein said second upright has a first and a second end, wherein one between said first and second ends slides on said first flap of said bottom rail.

3. The mosquito net according to claim 1, wherein said first flap has a continuous surface free of slits.

4. The mosquito net according to claim 1, wherein said curtain comprises at least one tensioning rope stretched between said first and second uprights, wherein said at least one tensioning rope is stably engaged with a first end to said first upright and is free to slide at least partially within said second upright, said tensioning rope being stably engaged with a second end thereof at a fixed position of one between said top and bottom rails.

5. The mosquito net according to claim 2, comprising guiding means of said second upright, said guiding means being placed in correspondence of said ends of said second upright sliding on said first flap, to maintain the sliding of said second upright along said bottom rail.

6. The mosquito net according to claim 5, wherein said second flap has a first rail, wherein said guiding means are configured to engage with said first rail configured to maintain the sliding of said guiding means along a determined direction.

7. The mosquito net according to claim 4, wherein said second upright has a first and a second end, wherein one between said first and second ends slides on said first flap of said bottom rail, the mosquito net comprising a collector of said at least one tensioning rope attached to said guiding means, to collect said at least one tensioning rope exiting said end of said second upright running on said first flap, and to convey said at least one tensioning rope towards said first rail.

8. The mosquito net according to claim 4, wherein said second flap has a second rail, wherein said fixed position in which said at least one tensioning rope is stably engaged with a second end thereof is a determined position along said second rail.

9. The mosquito net according to claim 1, wherein said first flap has an upper walkable surface and a lower supporting surface, wherein said upper walkable surface is disposed in the same plane as said floor, or, wherein said lower supporting surface is disposed in the same plane as said floor.

10. The mosquito net according to claim 1, wherein said bottom rail is straight and wherein said top rail has a longitudinal axis of main development at least partially curved.

11. The mosquito net according to claim 1, wherein said first and second uprights and said top and bottom rails have a transverse profile symmetrical with respect to its main axis of development.

12. The mosquito net according to claim 1, comprising a compensation element constrained with a first end vertical edge thereof to said first upright, and with a second end vertical edge thereof to said vehicle, to adapt said frame to different shapes of said vehicle.
